(19) United States
(12) Patent Application Publication
(10) Pub. No.: US 2017/0276120 A1
(43) Pub. Date: Sep. 28, 2017

(54) ENERGY GENERATION AND ACCUMULATION SYSTEM

(71) Applicant: Ashot G Petrosyan, Philadelphia, PA (US)

(72) Inventor: Ashot G Petrosyan, Philadelphia, PA (US)

(21) Appl. No.: 15/076,905

(22) Filed: Mar. 22, 2016

(51) Int. Cl. F03D 9/00; B60K 16/00; F03D 3/06; B60L 8/00; H02K 7/18; F03D 3/00

(52) U.S. Cl. CPC F03D 9/002; H02K 7/183; F03D 3/005; F03D 3/062; B60L 8/006; B60K 16/00; F05B 2220/706; B60K 2016/006

(57) ABSTRACT

An energy generation and accumulation system includes a housing having a first portion and a second portion, the second portion being environmentally sealed from the first portion, the first portion having an air inlet portion and an air outlet portion, the second portion having first and second sealed compartments, a power generation device providing; an air catching device disposed within the first portion, the air catching device for creating an axial rotational force on a first end of a shaft coupled to the air catching device. A generator for creating an electrical output and an accumulator disposed within the second sealed compartment for storing the electrical output of the generator is provided along with electronics for receiving, controlling and conditioning the output energy of the generator. The energy generation and accumulation system is capable of charging the accumulator while the system is in motion and while stationary.

### FIELD OF THE INVENTION

The present invention relates to an energy generation and accumulation system. More particularly, the invention relates to a unitized portable energy and accumulation system that generates and stores power.

### BACKGROUND OF THE INVENTION

Due to the worlds increased demand for greater energy efficiency, reduced energy consumption and CO2 emissions the need for renewable energy has grown exponentially. In fact, it has developed into one of the most widely discussed topics between nations on the planet. As a result of this increased public interest and demand for greater energy efficiency, it would be beneficial to provide an energy generating device that has the ability to create and store power with input from readily available natural sources. Consequently, the present invention provides an energy generating and storage system that makes use of the natural winds generated on the planet's surface. Additionally, it would be advantageous to provide a portable energy and accumulation system that may be moved from one location to another in order to make use of these natural winds to generate and store the electrical energy. The present invention contemplates these and other such advantageous energy and accumulation systems.

### SUMMARY OF THE INVENTION

Embodiments of the disclosure may include an energy and accumulation system that provides:

a housing having a first portion and a second portion, the second portion being environmentally sealed from the first portion, the first portion having an air inlet portion and an air outlet portion, the second portion having first and second sealed compartments,

a power generation device providing;

an air catching device mounted in a vertical direction and disposed within the first portion, the air catching device for creating an axial rotational force on a first end of a shaft coupled to the air catching device,

a generator connected to a second end of the shaft, the generator being mounted in the first enclosed sealed compartment and for creating an electrical output based on the air catching device's axial velocity of rotation, and

an accumulator disposed within the second sealed compartment, the accumulator for storing the electrical output of the generator,

electronics disposed within the second sealed compartment, the electronics for receiving and controlling and conditioning the output energy of the generator, wherein

the output energy of the generator is compatible with a level required by the accumulator, and wherein

the energy generation and accumulation system is capable of charging the accumulator by way of the air that passes across the air catching device and through the first portion both while the energy and accumulation system is in motion and while stationary.

In a first aspect of the present invention, the air catching device provides a plurality of air catching devices and the generator provides a plurality of generators connected to the plurality of air catching devices respectively by a plurality of shafts.

In a second aspect of the present invention, the energy and accumulation system may be mounted to the roof of an electrically powered vehicle.

In another aspect of the present invention, the energy and accumulation system is a portable, unitized system that is capable of being moved from one location to another.

In yet another aspect of the present invention, the accumulator is at least one of a storage capacitor and a car battery.

In yet another aspect of the present invention, the housing is aerodynamically designed in order to minimize wind resistance.

In yet another aspect of the present invention, a front width (FW) of the energy and accumulation system is wider than a rear width (RW) of the system.

In yet another aspect of the present invention, the front width (FW) of the housing gradually tapers towards the rear width (RW) of the energy and accumulation system.

In yet another aspect of the present invention, a difference in air pressure is realized at the narrow rear of the first portion.

In yet another aspect of the present invention, the accumulator is electrically connected to a vehicle's primary battery.

In yet another aspect of the present invention, the electronics includes a controller, rectifier and an inverter.

In yet another aspect of the present invention, the air catching device is a turbine that provides at least two blades mounted thereon.

In yet another aspect of the present invention, the generator creates an output that is capable of charging the accumulator when rotated in either a clockwise or counterclockwise direction.

In yet another aspect of the present invention, a minimum air velocity required to flow across the air catching device in order to generate energy is 11 miles per hour.

In a final aspect of the present invention, the output of the generator is increased by a factor of 4 when the electrically powered vehicle moves at a minimum speed between 40-50 miles per hour.

### BRIEF DESCRIPTION OF THE DRAWINGS

The invention will now be described, by way of example, with reference to the accompanying drawings, in which:

FIG. 1 is a perspective view of an energy and accumulation system according to a preferred embodiment of the present invention;

FIG. 2 is an exploded view of the energy and accumulation system according to the embodiment of FIG. 1;

FIG. 3 is a perspective view of an air catching device and generator assembly according to a preferred embodiment of the present invention.

FIG. 4 is a cross-section view of the turbine and generator assembly mounted to a top portion of the energy and accumulation system; and

FIG. 5 is a diagram showing a flow of energy from the turbine and generator assembly through to first and second accumulators.

### DETAILED DESCRIPTION OF REPRESENTATIVE EMBODIMENTS

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Hence, specific dimensions and other physical characteristics relating to the embodiments disclosed herein are not to be considered as limiting, unless the claims expressly state otherwise. In addition, it should be noted that a wire, electrical contact, electrical connector, etc., could be used as the form of electrical communication between internal device components.

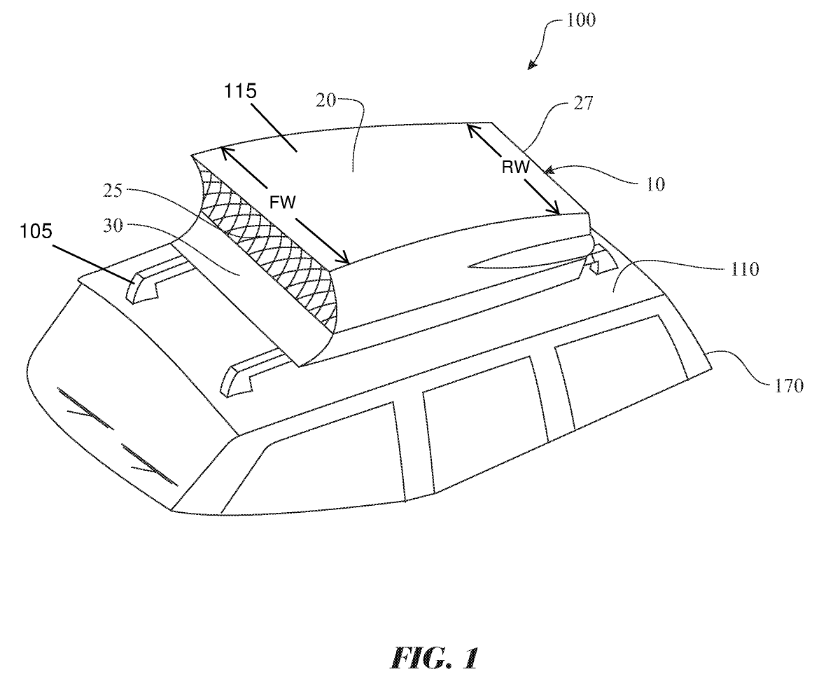

For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

An aerodynamic energy and accumulation system 100 shown mounted to a roof rack 105 is illustrated in FIG. 1. The roof rack 105 is in turn, mounted to the rooftop 110 of an electric vehicle 170. Since the present invention is designed to be portable and easily movable from one location to another, numerous applications of the present embodiment of this invention will function to accumulate and store energy in almost any outdoor environment. Examples of alternate embodiments (not shown) may include being mounted to the roof of a street vendor cart or to the roof of a boat/ship. The energy and accumulation system 100 could alternately be mounted to the roof of a house or even to a perch situated on the top of a pole. As a final example, the energy and accumulation system 100 may further sit at ground level on a windy beach.

The aerodynamic energy generation and accumulation system 100 provides a housing 10 that includes a first portion 20. The first portion 20 is then mounted on top of a second portion 30. The second portion 30 is environmentally sealed from the first portion 20. Insuring an environmental seal between the two portions 20, 30 is necessary in order to keep moisture and contaminates from damaging the internal components stored within the second portion 30. Examples of contaminates may include, but are not limited to bugs, dirt, soil, dust, sand, grime and mud. The environmental seal could be a hermetic seal by being for example, welded or epoxied together. The environmental seal could be a tongue and groove fit with the tongue extending upwards from the second portion 30 into the groove developed into the first portion 20 (or vice versa).

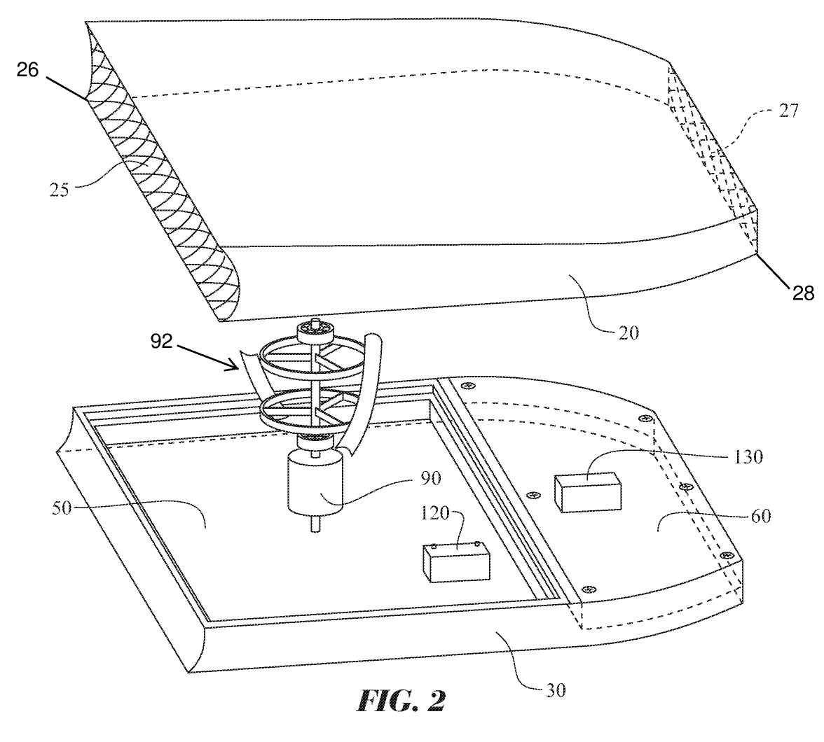

Referring now to FIGS. 1-2, the first portion 20 provides an air inlet portion 25 at a first end 26 and an air outlet portion 27 at a second end 28. The air inlet portion 25 accomplishes just that, it allows air to pass into the first portion 20 of the energy and accumulation system 100 and then out through the second end 28. The housing 10 is aerodynamically designed in order to minimize wind resistance. In the present embodiment, a front width (FW) of the energy and accumulation system 100 is wider than a rear width (RW) of the energy and accumulation system. This design of the present embodiment creates a pressure drop across the housing. This is because the air pressure is increased at the narrow rear of the first portion of the energy and accumulation system 100 from the air inlet portion 25 to the outlet portion 27. This difference in air pressure increases the air velocity within the housing.

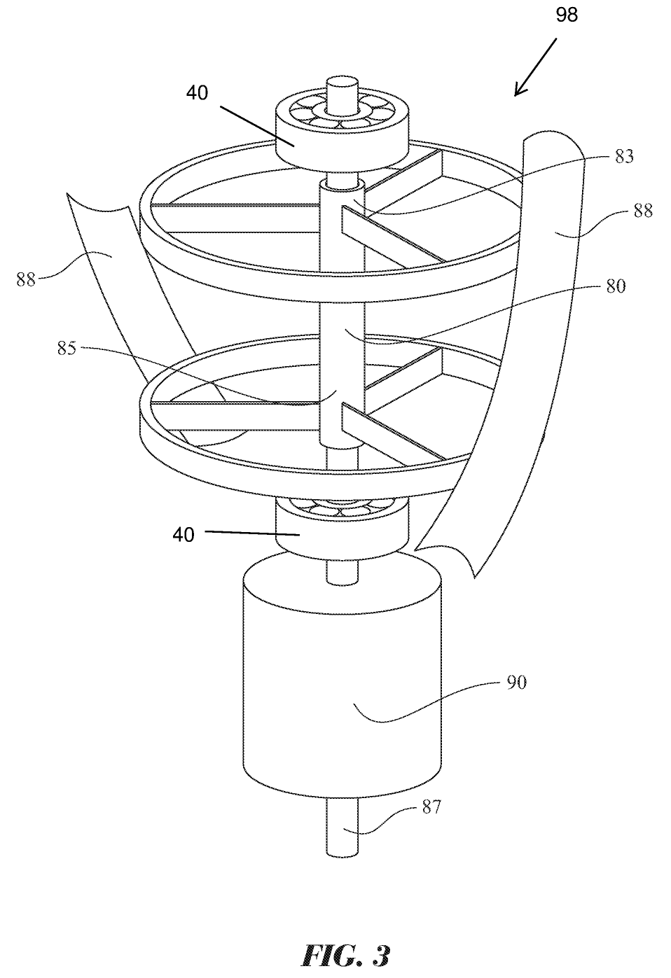

Referring now to FIGS. 2, 3, energy and accumulation system 100 includes a power generation device 98 that is oriented in a vertical fashion. The power generation device 98 could be fabricated from individual parts or could be directly purchased for example, from ALEKO Green Energy in Seattle, Wash. The power generation device 98 provides at least one air-catching device 80 that is coupled to a generator 90 by shaft 85. In present embodiment, the air-catching device 80 is a turbine that provides at least two blades 88, but other configurations of air catching devices having three or more blades are contemplated. They include, but are not limited to, squirrel cages, centrifugal blades, aluminum louver blades and cross-flow fan blades. In addition, the present invention contemplates using a plurality of power generation devices 98 in order to increase a charging capacity of the energy and accumulation system 100. As such, the air catching device 80 may provide a plurality of air catching devices and the generator 90 may provide a plurality of generators connected to the plurality of air catching devices respectively by a plurality of shafts 85.

As illustrated in FIG. 3, the vertically oriented air-catching device 80 is mounted at a first end 83 of the shaft 85 and the generator 90 is mounted at a second end 87 of the shaft 85. The power generation device 98 includes two bearings 40 that are fixed to the shaft 85. The first bearing 40 is mounted to the shaft 85 at the first end 83 of the shaft 85 (above the air catching device 80) and the second bearing 40 is mounted to a middle portion 86 of the shaft 85 (below the air-catching device 80 and above the generator 90. In the present embodiment, the air catching device 80 is a turbine 86 that provides at least three blades 88. In an alternate embodiment, the first portion 20 may be made from a single component. In such an embodiment, the air catching device 80 could be mounted in an alternate direction, but still within the upper and lower portions.

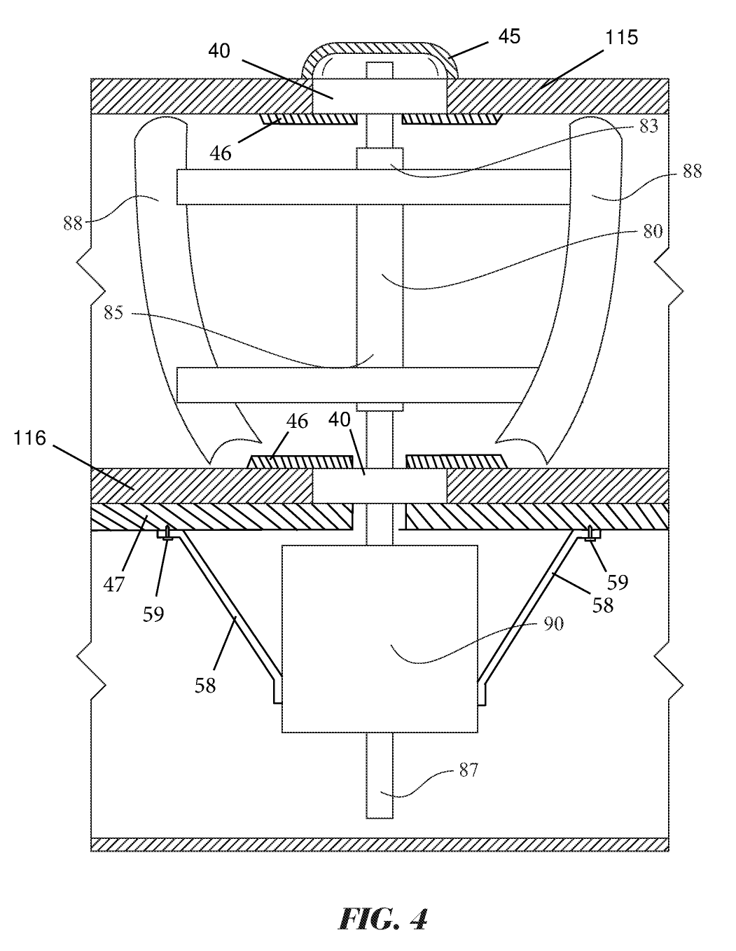

As illustrated in FIG. 4, the air-catching device 80 is mounted within upper and lower portions 115, 116 of the first portion 20. In the present embodiment, the first portion 20 is molded and made from two components. Therefore, the upper and lower portions would be made from a resilient plastic that can support the weight of the power generation device 98. In this embodiment, the bearings 40 are press fit into their respective upper and lower portions 115, 116. First, second and third bearing covers 45, 46 and 47 that seal the bearings from the external environment are provided in three strategic locations as shown.

In FIG. 2, the generator 90 is shown mounted within the second portion 30. Brackets 58 and screws 59 that secure and support the generator 90 to the third bearing cover 47 that are illustrated in FIG. 4 are provided. Although the present invention is not limited to any particular specialized mounting configuration. Here, the first portion 20 and second 30 portions are assembled together in order to form the energy and accumulation system 100. The second portion 30 provides first and second sealed compartments 50, 60 for housing components that will be forthcoming disclosed.

As air passes through the first portion 20 an axial rotational force is created on a first end 83 of a shaft 85. This is accomplished by virtue of the air/wind acting on the at least one air catching device 80. The generator 90 is mounted in the first enclosed sealed compartment 50 and creates an electrical output 95 based on the air catching device's axial velocity of rotation.

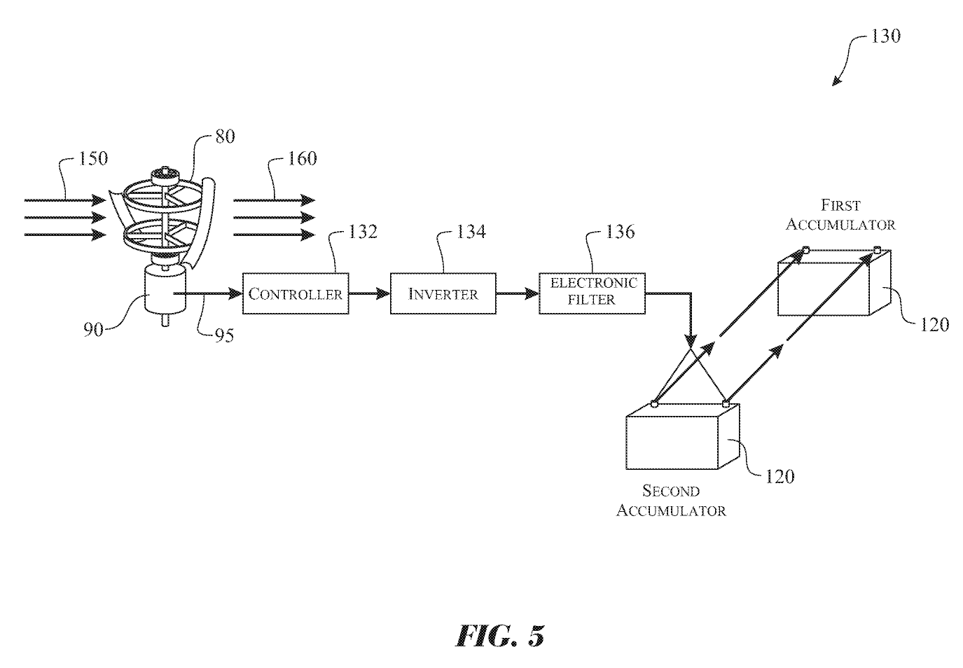

There is shown in FIG. 5, an accumulator 120 that is disposed within the second sealed compartment 60. The accumulator 120 provides a storage medium for storing the electrical output of the generator 90. In addition, electronics 130 that is disposed within the second sealed compartment is provided for receiving, controlling and conditioning the output energy of the generator. In the present embodiment, the electronics 130 includes a controller 132 and a rectifier 136. The controller controls the function of the rectifier. The rectifier takes the AC voltage generated by the generator, inverts/converts it to DC voltage and regulates the output. Here, where the energy generation and storage system is being used to supplant power to an electric vehicle, the output voltage of the rectifier is typically 12 Volts DC. However, the controller is designed to optionally be configured to output other voltages such as 18V, 24, 48 or any desired DC voltage desired. Further, an electronic filter 136 may be used in order to smooth out the output of the rectifier to produce a steady current

So, in theory any output voltage could be selected DC or AC and at any desired level. Therefore, an inverter could be used to invert a DC voltage output from the energy and storage system to an AC output. In the end, the electronics insures that the output energy of the generator is suitable to be received and stored by the accumulator for each application.

In the present embodiment, the accumulator may provide 2 or more accumulators that are electrically connected to the vehicle's primary 12 volt battery. Here, the output energy of the generator will be configured to be compatible with the level required to charge the car battery. In another embodiment, the accumulator may be a large capacity storage capacitor designed to sufficiently retain the energy output from the generator and then be transmitted to the vehicles primary 12 volt Battery. In an alternate embodiment, a plurality of accumulators or batteries could be provided within the energy and accumulation system. In yet another embodiment, the vehicle could provide a plurality of batteries that are charged by the energy and accumulation systems accumulator.

It should be well noted that the energy generation and accumulation system 100 is capable of charging the accumulator 120 both while the energy and accumulation system 100 is in motion and while stationary. This is because air in the form of wind is normally generated by the motion of the earth and by the varying temperatures on its surface. When the energy and accumulation system is stationary, this wind will drive the energy and accumulation system to create and store energy with no other input energy required. So, in a sense, this stored energy is obtained essentially at no cost. The minimum air velocity that is required to flow within and through the air catching device in order to generate power is approximately 11 miles per hour. However, the output of the generator is increased by a factor of four when the electrically powered vehicle moves at a speed between 40-50 miles per hour.

The generator provided within the energy generation and accumulation system is capable of charging the accumulator when rotated in either a clockwise or counterclockwise direction. Here, the amplitude of the AC output voltage remains the same, but the polarity of the generator output reverses. This is not a problem because the controller of the present invention is designed to sense the reverse in polarity and then control the rectifier to adjust for the change. Therefore, if the direction of the wind reverses and flows in through the air outlet portion instead of the air inlet portion, the energy generation and accumulation system will still generate and store the power generated.

As an example of the present inventions capabilities and value, if a vehicle having the energy and accumulation system mounted thereon is driven to the beach, as long as the vehicle exceeded a speed of 11 miles per hour during the trip, free stored energy will be generated and stored. Additionally, if the energy and accumulation system is removed from the vehicle and placed on the beach/sand, as long as the velocity of the wind exceeds 11 miles per hour free energy will be generated and stored. The stored energy in the form of electrical power may be used to run an electric vehicle. Alternately, the energy and accumulation system may be connected to an external step up inverter to run any type of 115 Volt AC 15 Amp device desired. As an example, wouldn't be nice to obtain free power and be able to run (for example) a refrigerator, a hot plate or microwave on the beach, without the gasoline smell from a generator.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

Reference Elements:

| Ref. No. | Description |
|---|---|
| 10 | housing |
| 20 | first portion of the housing |
| 25 | air inlet portion |
| 26 | first end of the air inlet portion |
| 27 | an air outlet portion |
| 28 | second end of the air outlet portion |
| 30 | second portion of the housing |
| 40 | bearing |
| 45 | first bearing cover |
| 46 | second bearing cover |
| 47 | third bearing cover |
| 80 | air catching device |
| 83 | top portion of shaft |
| 85 | shaft, power generation device |
| 86 | middle portion of shaft |
| 87 | bottom portion of shaft |
| 88 | blade |
| 90 | generator |
| 98 | power generation device |
| 95 | electrical output |
| 100 | energy generation and accumulation system |
| 105 | roof racks |
| 110 | roof top of vehicle |
| 115 | upper portion of first portion |
| 116 | lower portion of first portion |
| 120 | accumulator or battery |
| 130 | electronics |
| 132 | controller |
| 134 | inverter |
| 136 | electronic filter |
| 150 | air flow across turbine |
| 170 | electrically powered vehicle |
| FW | front width |
| RW | rear width |

1. An energy generation and accumulation system comprising:
a housing having a first portion and a second portion, the second portion being environmentally sealed from the first portion, the first portion having an air inlet portion and an air outlet portion, the second portion having first and second sealed compartments,
a power generation device providing;
an air catching device mounted in a vertical direction and disposed within the first portion, the air catching device for creating an axial rotational force on a first end of a shaft coupled to the air catching device,
a generator connected to a second end of the shaft, the generator being mounted in the first enclosed sealed compartment and for creating an electrical output based on the air catching device's axial velocity of rotation, and
at least one accumulator disposed within the second sealed compartment, the at least one accumulator for storing the electrical output of the generator,
electronics disposed within the second sealed compartment, the electronics for receiving and controlling and conditioning the output energy of the generator, wherein
the output energy of the generator is compatible with a level required by the at least one accumulator, and wherein
the energy generation and accumulation system is capable of charging the accumulator by way of the air that passes across the air catching device and through the first portion both while the energy and accumulation system is in motion and while stationary.

2. The energy generation and accumulation system according to claim 1, further comprising being mounted to the roof of an electrically powered vehicle.

3. The energy generation and accumulation system according to claim 1, wherein the air catching device provides a plurality of air catching devices and the generator provides a plurality of generators connected to the plurality of air catching devices respectively by a plurality of shafts.

4. The energy generation and accumulation system according to claim 1, wherein the energy and accumulation system is a portable, unitized system that is capable of being moved from one place to another.

5. The energy generation and accumulation system according to claim 1, wherein the accumulator is at least one of a capacitor and a battery.

6. The energy generation and accumulation system according to claim 1, wherein the housing is aerodynamically designed in order to minimize wind resistance.

7. The energy generation and accumulation system according to claim 6, wherein a front width (FW) of the system is wider than a rear width (RW) of the system.

8. The energy generation and accumulation system according to claim 6, wherein the front width (FW) of the housing gradually tapers to the rear width (RW).

9. The energy generation and accumulation system according to claim 6, wherein air pressure is increased at the narrow rear of the first portion.

10. The energy generation and accumulation system according to claim 2, wherein the accumulator is electrically connected to the vehicle's primary battery.

11. The energy generation and accumulation system according to claim 1, wherein the electronics includes a controller, rectifier and an electronic filter.

12. The energy generation and accumulation system according to claim 1, wherein the air catching device is a turbine that provides at least two blades mounted thereon.

13. The energy generation and accumulation system according to claim 1, wherein the generator creates an output that is capable of charging the accumulator when rotated in either a clockwise or counterclockwise direction.

14. The energy generation and accumulation system according to claim 1, wherein a minimum air velocity required to flow across the air catching device in order to generate energy is 11 miles per hour.

15. The energy generation and accumulation system according to claim 2, wherein the output of the generator is increased by a factor of 4 when the electrically powered vehicle moves at a minimum speed between 40-50 miles per hour.

16. The energy generation and accumulation system according to claim 1, further comprising the system being mounted to the roof of a street vendor cart.

17. The energy generation and accumulation system according to claim 1, further comprising the system being mounted to the roof of one of a boat and a ship.

18. The energy generation and accumulation system according to claim 1, further comprising the system being disposed at ground level on a sandy beach.

19. The energy generation and accumulation system according to claim 1, further comprising the accumulator providing a plurality of accumulators in order to increase a storage capacity.

20. The energy generation and accumulation system according to claim 1, wherein the electronics includes a controller, inverter and an electronic filter and the system is capable of generating enough power to run 115 Volt AC appliances having a maximum wattage requirement of 15 amps without any external input power required.
